(19) United States
(12) Patent Application Publication
(10) Pub. No.: US 2011/0022475 A1
(43) Pub. Date: Jan. 27, 2011

(54) DISTRIBUTION OF PROMOTIONAL DATA AND RECEIPT OF CUSTOMERS' REACTIONS TO THE DATA

(76) Inventors: Elad Inbar, Tel-Aviv (IL); Sephi Shapira, Ramot-HaShavim (IL)

Correspondence Address: MARTIN D. MOYNIHAN d/b/a PRTSI, INC., P.O. BOX 16446, ARLINGTON, VA, 22215, US

(21) Appl. No.: 12/681,112

(22) PCT Filed: Mar. 18, 2008
(86) PCT No.: PCT/IL08/00378

§ 371 Date: Oct. 18, 2010

Related U.S. Application Data
(60) Provisional application No. 60/960,555, filed on Oct. 3, 2007.

(51) Int. Cl. G06Q 30/00

(52) U.S. Cl. 705/14.66

(57) ABSTRACT

A system for evoking positive customer reactions to a promotional activity for advertising entities on demand. The system comprises an input unit for receiving a bid for a positive reaction to a promotional activity from an advertising entity, a customer-targeting unit for generating a promotion list that specifies potential customers based on the bid, and an output unit configured for outputting said promotion list. The generated promotion list is calculated to evoke a sufficient amount of positive customer reactions to the promotional activity from the plurality of potential customers to meet said bid.

### FIELD AND BACKGROUND OF THE INVENTION

The present invention relates to a system, a method, and an apparatus for distributing promotional data and, more particularly, but not exclusively to a system, a method, and an apparatus for distributing promotional data and receiving reactions to the promotional data from promoted customers.

As commonly known, some of today's marketing activities and promotions may be targeted to a group of potential customers that have one or more common characteristics. The targeted potential customers are chosen according to an estimate made by the promoters and the marketers based on the common characteristics that correspond to the typical purchaser of the promoted product or service. By using targeted promotions, the cost, which is associated with sending numerous promotion offers, is reduced.

U.S Patent Application No. 2002/0161779, published on Oct. 31, 2002 discloses a system and method for populating and analyzing a member customer profile database for implementing an incentive driven targeted product marketing program. To implement the targeted product marketing program, personal profile information is collected from several member customers and stored in a profile database. A group of the member customers are identified and selected, and the promotion system operator provides a promotion to this group on behalf of a sponsor. During and/or after the promotion, information is solicited from the member customer about the promotion in exchange for rewards. In addition, interactive behavior information of the member customer is tracked. The solicited information and the interactive behavior information can then be used to enrich the profile database for future promotions.

Another targeted promotion system and method is described in PCT/IL2006/00402, published as WO2006/111952 on Oct. 26, 2006 and herein incorporated by reference that teaches a customer-targeting tool that allows a user to find potential customers from sparse data. The customer-targeting tool comprises a discovery unit for analyzing customer data regarding customer reaction to previous promotion activity and identifying groupings from customers differentiated by the reactions. The customer-targeting tool further comprises a targeting unit for targeting customers belonging to groups discovered from customers showing certain reactions, such as positive reactions. Using the customer discovery tool, the system operator may empirically predict the likelihood that a specific interaction with a customer will result in a specific action.

Though such system provides a targeted promotion that is usually more efficient than an untargeted promotion, there is a need for new systems that provide new advanced promotion capabilities.

### SUMMARY OF THE INVENTION

According to one aspect of the present invention there is provided a system for evoking positive customer reactions to a promotional activity for advertising entities. The system comprises an input unit for receiving a bid for at least one positive reaction to a promotional activity from an advertising entity and a customer-targeting unit for generating a promotion list specifying a plurality of potential customers based on the bid. The generated promotion list is calculated to evoke a sufficient amount of positive customer reactions to the promotional activity from the plurality of potential customers to meet the bid. The system further comprises an output unit for outputting the promotion list.

Optionally, the bid comprises a preferred timing for receiving the positive customer reactions; the evoking is performed during the preferred timing.

Optionally, the bid comprises a demand for a predefined number of positive customer reactions.

Optionally, the promotion list is calculated according to empirical analysis of customer data.

Optionally, a cost of promoting the plurality of potential customers is less than a product of the bid and the amount.

Optionally, the customer-targeting unit is for generating the promotion list automatically.

Optionally, the input unit is connected to at least one user interface for allowing an advertising entity to input the bid.

More optionally, the at least one user interface is for allowing the advertising entity to input at least one promotion property, the customer-targeting unit is for generating the promotion list according to the at least one promotion property.

More optionally, the at least one promotion property comprises a member of the following group: promotional data, a timing for setting the promotional activity, a pace in which the positive customer reactions is received, a date for setting the promotional activity, a minimum limit for the amount, a maximum limit for the quantity of the amount, a list defining plurality of unwanted potential customers, at least one property defining plurality of unwanted potential customers, a list defining a plurality of wanted potential customers, and at least one property defining plurality of wanted potential customers.

More optionally, the at least one user interface is for allowing the advertising entity to input a preferred promoting method, the output unit is configured to instruct a distributing unit to conduct the promotional activity according to the preferred promoting method.

More optionally, the input unit is connected to the at least one user interface via a computer network.

Optionally, the input unit is for receiving a plurality of bids for a plurality of promotional activities from a plurality of user interfaces. The customer-targeting unit is for generating a plurality of promotion lists based on the plurality of bids, each the promotion list is calculated to evoke at least one positive customer reaction to a respective the promotional activity, the output unit is for outputting the plurality of promotion lists.

More optionally, the input unit is for to prioritize the plurality of bids.

Optionally, the output unit is for outputting the promotion list to a distributing unit, the distributing unit is for distributing the promotional activity according to the promotion list.

Optionally, the promoting is performed instantaneously after the reception of the bid.

According to one aspect of the present invention there is provided a method for evoking positive customer reactions to a promotional activity for advertising entities. The method comprises a) receiving a bid for a positive customer reaction to a promotional activity from an advertising entity, b) generating a promotion list specifying a plurality of potential customers based on the bid, the generated promotion list is calculated to evoke a sufficient amount of positive customer reactions to the promotional activity from the plurality of potential customers to meet the bid, and c) outputting the promotion list.

Optionally, the cost of promoting the plurality of potential customers is less than a product of the bid and the amount.

Optionally, the bid comprises a predefined promotion period, the generated promotion list is calculated to evoke the positive customer reactions during the predefined promotion period.

More optionally, the method further comprises empirically analyzing customer data before the promotion list generating, is based on the analysis.

More optionally, the method further comprises receiving at least one promotion property, the generating Is based on the at least one promotion property.

According to one aspect of the present invention there is provided a user terminal for evoking at least one positive customer reaction to a promotional activity. The user terminal comprises a user interface for allowing a user to define a reward for a positive reaction to a promotional activity and an output unit for forwarding the reward to a promotion generating unit via a computer network. The promotion generating unit is for conducting a promotion based on the reward, the promotion is calculated to evoke at least one positive customer reaction to the promotional activity for a profitable cost.

Optionally, the profitable cost is lower than a product of the reward and the quantity of the at least one positive customer reaction.

Optionally, the promotion is conducted to evoke the at least one positive customer reaction immediately.

Optionally, the user interface for allowing the user to define at least one promotion property, the output unit for forwarding the at least one promotion property to the promotion generating unit, the promotion generating unit is for conducting the promotion according to the at least one promotion property.

According to one aspect of the present invention there is provided a system for evoking at least one positive customer reaction to a promotional activity for advertising entities. The system comprises an input unit for receiving from an advertising entity a preferred timing for receiving at least one positive reaction to a promotional activity and a customer-targeting unit for generating a promotion list of potential customers based on the preferred timing. The promotion list is calculated to evoke the at least one positive customer reaction in the preferred timing. The system further comprises an output unit for outputting the promotion list. The principles and operation of an apparatus and method according to the present invention may be better understood with reference to the drawings and accompanying description.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a customer on demand (COD) system for evoking one or more positive reactions to a promotional activity, according to one embodiment of the present invention;

FIG. 2 is a flowchart of a method for executing for evoking one or more positive reactions to a promotional activity, according to one embodiment of the present invention;

FIG. 3 is a simplified diagram illustrating a graph with three axes that graphically illustrates a plane that maps a plurality of potential customers, according to one embodiment of the present invention;

FIG. 4 is a schematic illustration of the customer on demand system and a number of distributed advertising entity interfaces, according to one embodiment of the present invention;

FIG. 5 is a schematic illustration of a customer demand tool for identifying and targeting potential customers, according to one embodiment of the present invention;

FIG. 6 is another schematic illustration of a customer demand tool for identifying and targeting potential customers, according to one embodiment of the present invention; and

FIG. 7 is a schematic illustration of the customer demand tool that is depicted in FIG. 5 and additional participates in the promotional activity, according to one embodiment of the present invention.

### DESCRIPTION OF THE EMBODIMENTS

The present embodiments comprise a promoting system and a method for evoking positive customer reactions to a promotional activity on demand. The advertising entity submits a bid that defines a reward for each customer reaction that is received as a response to the promotional activity, which may be an offer to purchase a product and/or a service. The bid may define characteristics of the customer reaction, such as the time and/or the date of the customer reaction, the number and/or the pace of customer reactions, and/or a total budget for the promotional activity, as further described below. In one embodiment of the present invention, a predefined amount of positive customer reactions is evoked at a controllable pace in predefined period, optionally shortly after the bid has been submitted.

The positive customer reactions are evoked from a group of potential customers that have been selected as they can be promoted for a profitable cost. Optionally, the profitable cost is lower than a product of reward and the number of the positive customer reactions which are received in response to the promotional activity.

The promoting system allows an advertising entity to set a fixed reward for every customer reaction it receives as a result of the promotion and optionally to determine the quantity of the positive customer reactions and/or timing of the receipt of the positive customer reactions. It should be noted that the advertising entity may not be able to determine which customer reactions have been evoked by the promotion activity. Optionally, the promoting system allows an advertising entity to set a limit to the number of customer reactions it is ready to receive as a result of the promotion.

The promoting system allows the advertising entity to initiate a promotion with outcomes which are known in advance. The system allows the advertising entity to define the timing, the quantity, and cost of positive reactions to its promotional activity. In such a manner, the advertising entity may estimate the resources, such as the work force, budget, and advertisement materials, it has to allocate for the expected customer reactions in advance. In such a manner, the advertising entity does not have to adjust the resources which are needed to support the calls as it can pace the customer reactions to the currently available support.

According to one aspect of the present invention there is provided a promoting system that comprises a customer demand unit for receiving a bid that defines a reward for a positive reaction from an advertising entity and a customer-targeting unit for generating a promotion list of potential customers. It should noted that a bid may be understood as a demand for customers. The promotion list is calculated to evoke customer reactions in a profitable cost according to the reward in the received bid. The system further comprises an output unit that outputs the promotion list, optionally to a distribution unit that distributes a promotion to its members.

Optionally, the customer-targeting unit may use a customer-targeting tool that is disclosed in PCT/IL2006/00402, published as WO2006/111952 on Oct. 26, 2006 and incorporated herein by reference for generating the promotion list.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

An advertising entity may be understood as an entity, such as a person or a company, which is willing to pay a specified amount for one or more customer reactions, such as a response call, an access to a certain website or the like, an arrival to a predefined location or an event, a replay to a questionnaire, a participation in a game of chance, a registration to a service, etc.

Potential customers, customers, users or user identifiers may be understood as: mobile users obtained by mobile station integrated services digital networks (MSISDN), individual users obtained by usernames and password combinations, unique identifier identities or any other form of authentication to uniquely identify the users.

Communication actions or interactions may be understood as: a phone call, purchasing event, arriving to a specific destination, sending or receiving a short message service (SMS), a multimedia messaging service (MMS), an enhanced messaging service (EMS), a phone call, or an IVR call. In addition, this may include switching between different WEB pages or television channels, connecting to a specific wireless or wired network, using a satellite or cable receiver, reacting to an interactive voice response (IVR), accessing e-mail and text-based WebPages using a mobile phone, and any other form of recordable interaction that a potential customer can do consciously or unconsciously with any system or communication network or application server as recorded over the online world.

A promotional message may be understood as one or more of the following messages: an SMS message, a WAP push message, a WAP page, a MMS message, a banner, a fax message, an interactive television message, an email message, a web page, an IVR recording, a phone call, a voicemail recording, an advertisement of any kind, a churn management promotion, a price plan promotion, a printed message on the monthly bill, and any other form of message delivered to a user. Each one of the aforementioned promotional messages may comprise marketing content, advertising, a registration invitation or any other form of content that should be delivered to customers by any advertising entity or marketer who wishes to address potential customers with a targeted promotion.

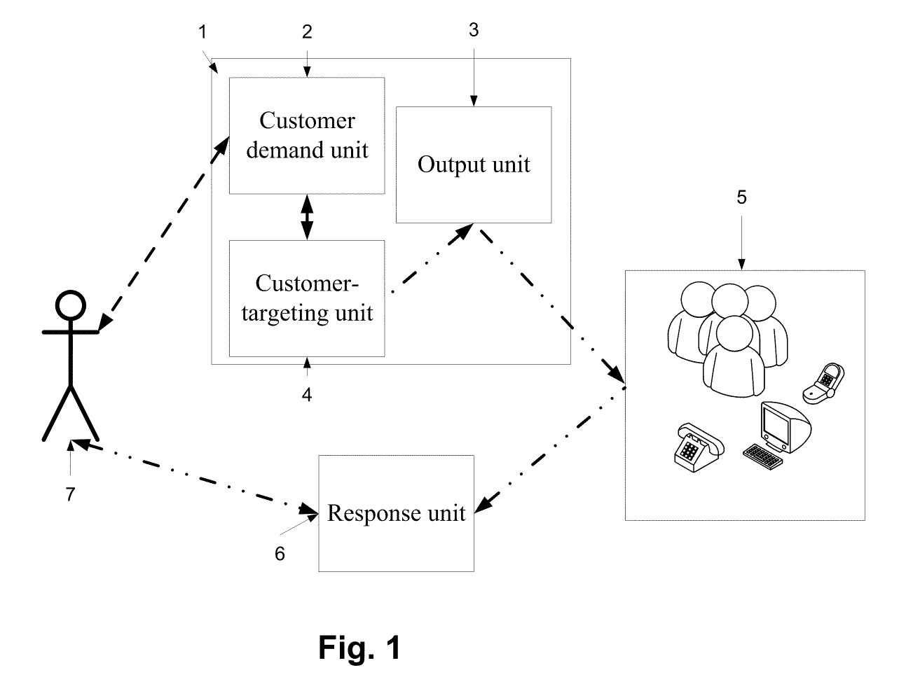

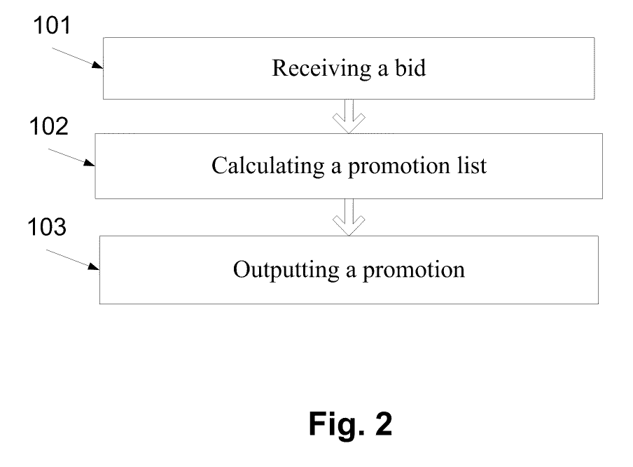

Reference is now made to FIG. 1, which is a schematic illustration of a system, which may be referred to as a customer on demand (COD) system 1, for evoking a positive reaction to a promotional activity as a response to a bid, which may be understood as a demand for customers, received from an advertising entity or a system operator, according to one embodiment of the present invention. The system allows an advertising entity 7 and/or a system operator to input a bid for a desirable reaction of a potential customer to a promotion, which may be referred to a positive customer reaction. The positive customer reaction may be a purchase of a service or a product, an arrival to a promotional event, and an expression of interest, such as a call to a call center or visiting a website. Jointly, reference is also made to FIG. 2, which is a flowchart of a method for evoking a positive reaction to a promotional activity as a response to a bid received from an advertising entity or a system operator, according to one embodiment of the present invention. The method allows the execution of a promotion according to a list of potential customers that has been calculated according to a reward defined in the bid.

The COD system 1 comprises a customer demand unit 2 that is designed for receiving the bid from the advertising entity 7, as shown at 101, a customer-targeting unit 4, and an output unit 3. The bid may be received directly via a user interface, as described below, or from a system operator of the COD system 1. The bid includes a reward that the advertising entity 7 is ready to offer for a positive customer reaction to a promotional activity, such as a promotional message sent in connection with the promotional activity. For clarity, it should be noted that a promotion or a promotional activity may be understood as a means for providing one or more promotional messages or as a process of sending one or more promotional messages. A promotional message may be understood as one or more of the following messages: an SMS message, a WAP push message, a WAP page, a MMS message, a banner, a fax message, an interactive television message, an email message, a web page, an IVR recording, a phone call, a voicemail recording, an advertisement of any kind, a churn management promotion, a price plan promotion, a printed message on the monthly bill, and any other form of message delivered to a user. Each one of the aforementioned promotional messages may comprise marketing content, advertising, a registration invitation or any other form of content that should be delivered to customers by any advertising entity or marketer who wishes to address potential customers with a targeted promotion.

Optionally, the advertising entity 7 defines one or more promotion properties, such as a payment per positive customer reaction, a promotion budget that defines a total that the advertising entity 7 is ready to pay for positive customer reactions resulting from the aforementioned promotion, a channel through which user responses will arrive, a promotional message, a time constraint, a pace constraint and any other promotion property as may be required by the system.

The customer demand unit 2 receives the bid from the advertising entity 7 and instructs the customer-targeting unit 4 to yield a list of potential customers, as described below. The size and/or the contents of the list of potential customers are calculated to evoke positive customer reactions for a cost per positive customer reaction that is lower than the reward defined in the bid. The list is forwarded to the output unit 3, which is optionally connected to one or more distribution means, such as SMS messaging server and an e-marketing server. The distribution means distributes the promotional messages to members of the list of potential customers.

Optionally, the customer demand unit 2 is connected to a user interface that allows the advertising entity 7 to initiate a promotion with known in advance outcomes. The user interface allows the advertising entity 7 to submit the bid that defines the reward for positive reaction to the promotion. The advertising entity can use the reward to calculate the cost of the promotion. In such a manner, the advertising entity may estimate the cost of the promotion in advance. Optionally, the user interface includes a button that allows the advertising entity to initiate the promotion immediately or in a predefined timing. Optionally, the user interface allows the advertising entity to define the number of positive customer reactions it wishes to receive as a result of the promotional activity. As it is possible to define the number of responses it is likewise possible to define the rate of responses by moderating the rate of promotional messages. In such a manner, the advertising entity may estimate the work force, budget, and advertisement materials in advance.

Optionally, the customer-targeting unit 4 may comprise a customer discovery tool that includes customer data and customer profiles. Optionally, the customer-targeting unit 4 comprises a customer-targeting tool as defined in PCT/IL2006/00402, published as WO2006/111952 on Oct. 26, 2006 and incorporated herein by reference. It should be noted that other learning mechanism and data mining system may be used for generating a list of potential customers for a targeted promotion.

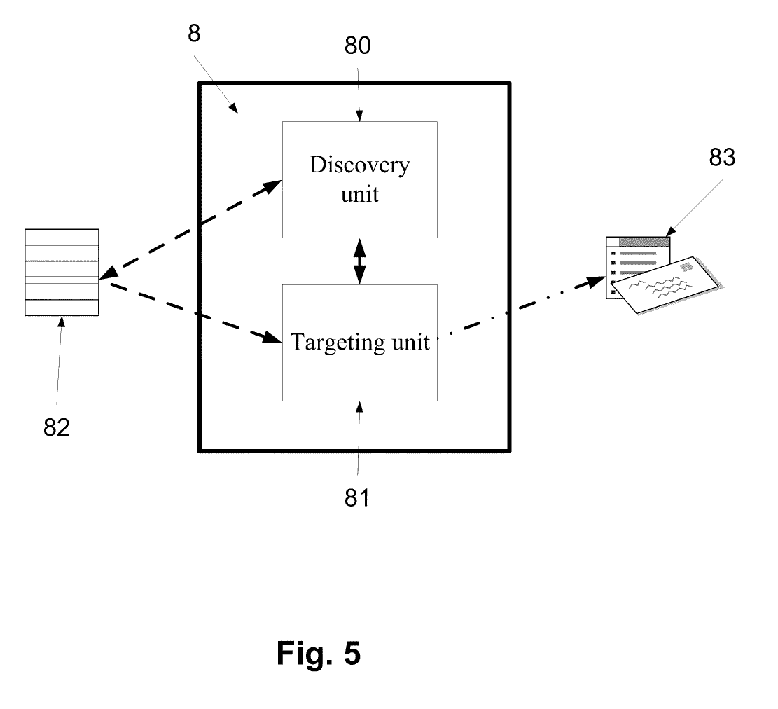

In such an embodiment, the customer-targeting unit 4 uses the customer discovery tool to yield a list of potential customers targeted for promotion by combining data mining models, genetics algorithms, natural selection algorithms, pattern recognition algorithms, prediction algorithms and the like. A detailed description of such an exemplary customer discovery tool is given below, in relation to FIGS. 5, 6, and 7.

The customer discovery tool includes a discovery unit for discovering the most relevant customers for the promotional message, optionally by empirically analyzing customer data regarding customer reactions to the earlier promotion. Optionally, the customer discovery tool includes customer data and customer profiles. Optionally, the list of potential customers is based on actual customer data, such as documented communication actions or interactions a potential customer may perform. Such an approach may be referred to as empirical marketing, and is herein called customer discovery. That is to say, the customer discovery tool in fact finds out more about the potential customer than merely binary information about his likelihood to respond. The tool provides details of those customers who actually responded to the earlier promotion. The customers who responded are mapped on a plane, based on their profile information, and data mining models, natural selection and genetic algorithms may then be used to find where the responding customers cluster on the plane and which other customers fit the profiles of the clusters and can therefore be identified as potential customers. The actual customers together with potential customers that cluster with the actual customers may then be used to form new targeted promotion lists. Optionally, groupings or clusters of customers differentiated by the reactions to documented promotions are identified.

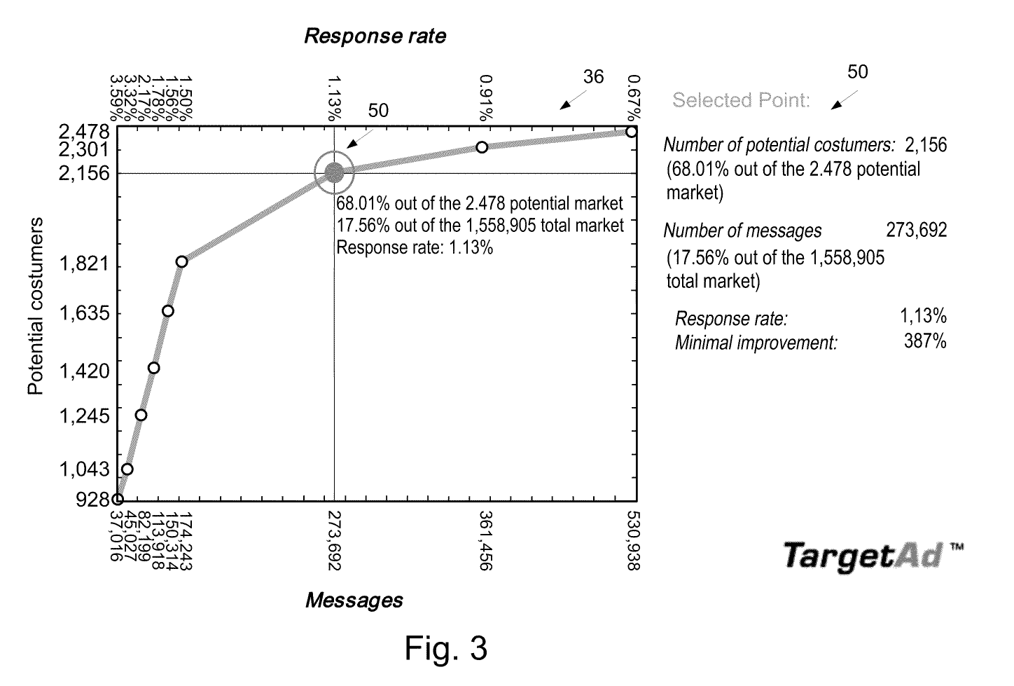

Reference is now made to FIG. 3, which is a simplified diagram illustrating a graph 36 with three axes that graphically illustrates a plane that maps potential customers, according to one embodiment of the present invention. The three axes are a response rate, a recall rate, and a promotion size. Each axis is a domain of the plane that may affect the generation of the list of potential customers. The bottom axis shows the size of different groups and/or clusters of potential customers for targeted promotion. The left axis shows the total expected users. The top axis shows the response rate. Each point on the graph is a possible, but not necessarily realistic, target point that estimates the outcome of a certain promotion.

Optionally, the customer discovery tool stores one or more records that define the cost of possible promotional activities such as sending promotional messages to one or more potential customers. As described above, in use the advertising entity 7 inputs a bid that defines the reward that it is willing to pay for a positive reaction to the promotional activity. Optionally, the customer discovery tool calculates the response rate to the promotional activity over a given group of customers. In such a manner, the profitability of each one of the target points may be categorized, for example based on the ratio between the response rate of a certain group and the cost of a promotional activity that is intended to the certain group.

As shown at 102 of FIG. 2, the customer targeting unit 4 calculates the promotion list for evoking positive customer reactions within the profitable cost range. Optionally, the cost of a promotion, which is based on the promotion list, is lower than the total of estimated rewards which are received from the execution of the promotion. Optionally, the selected promotion is the promotion that maximizes the revenues of the operator of the COD system 1.

For example, if the advertising entity 7 defines a $100 reward for a positive customer reaction, the COD system generates a promotion list that defines a group of potential customers that may be promoted for less than a product of the number of the estimated positive customer reactions, which is optionally based on the response rate of the listed group, and $100. An example for such a promotional activity is sending promotional messages to a cumulative number of customers for a certain amount of promotional effort in a manner that the promotion cost per customer who responded positively is lower than $100.

Optionally, the customer discovery tool automatically chooses a group of customers with the highest response rate of estimated positive reactions. For example, in the exemplary plane that is depicted in FIG. 3, the customer discovery tool chooses point 50 that has the highest estimated response rate. The customer targeting unit 4 verifies that the cost of promoting the members thereof is lower than the product of the received reward and the estimated positive reactions which are expected from the group. Optionally, if the cost of promoting the members of the group is higher than the product of the received reward, the customer targeting unit 4 stops the process of evoking positive reactions and optionally notifies to the advertising entity 7 about the stop. In such a manner, only profitable promotions that cost less than the rewards which are received for the execution thereof are conducted.

Optionally, the plane that is depicted in the graph 36 is a dynamic plane based on customer data that is updated every promotion, for example as described in PCT/IL2006/00402, published as WO2006/111952 on Oct. 26, 2006, incorporated herein by reference.

Reference is now jointly made, once again, to FIGS. 1 and 2. As disclosed in patent number PCT/IL2006/00402 and described above, the customer discovery tool outputs a promotion list that comprises a group of potential customers. The customer discovery tool forwards the promotion list to the customer-targeting unit 4 that forwards it to the output unit 3.

As shown at 103, the promotion is sent to the members of the list of potential customers. Optionally, the output unit 3 forwards the promotional data of the advertising entity 7 to one or more broadcasting servers, which are used to distribute it to the customers listed in the targeted promotion list.

As described above, the COD system 1 receives from the advertising entity 7 a bid that defines how much it is ready to pay for one or more positive customer reactions. The promotion generation unit 2 of the COD system 1 generates a promotion that evokes positive customer reactions for a total cost that is lower than the product of the reward that is defined in the bid and the number of the positive customer reactions. For example, the advertising entity 7, such as a car distributor, submits a bid at the customer demand unit 2 that specifies a reward of $100 per visit of a potential customer in a showroom, a subscription to the company's website, and/or a call to the company's call-center. The customer targeting unit 4 identifies a group of potential customers that should be promoted in order to achieve the highest response rate for the lowest cost according to the received reward and an estimate cost of the promotion. The group is calculated, in the light of the submitted bid, in a manner that the product of the number of estimated positive customer reactions to the promotion and the reward leaves a predefined margin to the system operator over the promotion cost. It should be noted that in such a manner, the income from sending the promotion is higher then the cost of the execution thereof and therefore the system operator of the COD system 1 has an incentive to carry out the promotion. The customer targeting unit 4 forwards a targeted promotion list that comprises a group of potential customers to the output unit 3. The output unit 3 sends a promotion that is based on the promotional data to the potential customers of the targeted promotion list. For example, each potential customer receives an SMS that includes an invitation to visit the showroom or the website of the company or a telephone number of a call center she may use.

Optionally, the response unit 6 is designed to receive customer reactions to promotional data or to provide the service and/or the product that is marketed by the promotional data. Optionally, the response unit 6 includes one or more call centers, servers, and/or response collector servers, which are adjusted to receive and optionally identify the customer reactions.

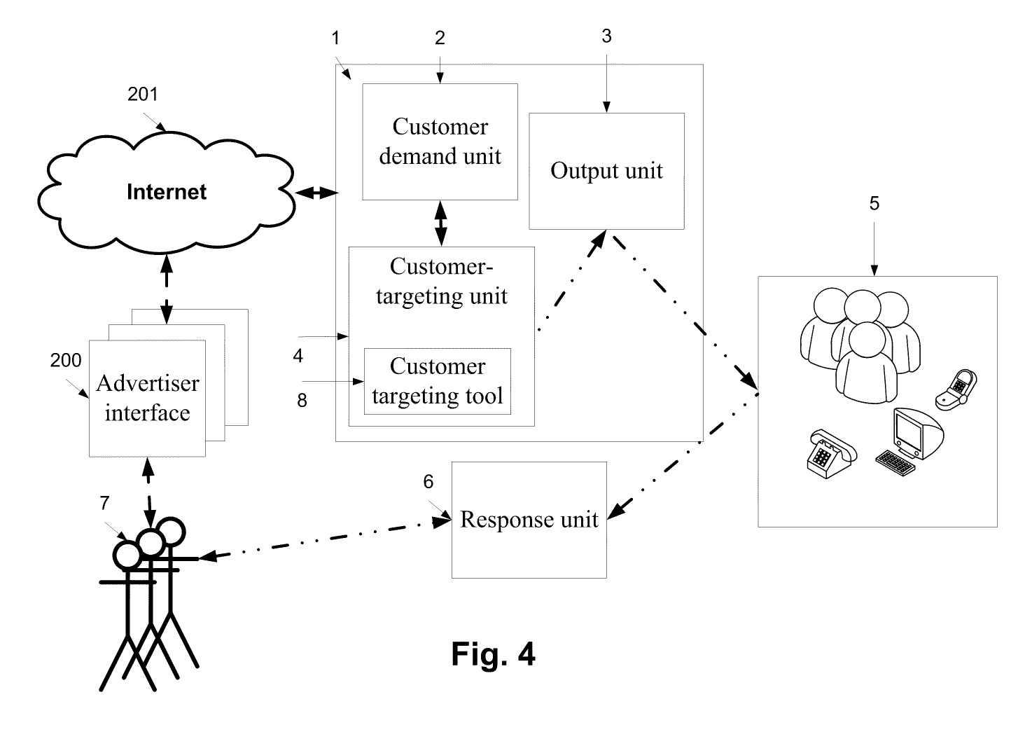

Reference is now made to FIG. 4, which is a schematic illustration of the COD system 1 and a number of distributed advertising entity interfaces 200, according to one embodiment of the present invention. The COD system 1 and the one or more advertising entities 7 are as depicted in FIG. 1. However, FIG. 2 further depicts one or more advertising entity interfaces 200, the aforementioned customer-targeting tool 8, and a network 201.

Optionally, the COD system 1 is installed on a central server or a pool of servers, which are connected to the Internet, and the one or more advertising entity interfaces 200 are installed in workstations, which are connected to the COD system 1 via a computer network, such as the Internet 201. Optionally, the advertising entities 7 submit the aforementioned bids using the advertising entity interface 200.

Optionally, the advertising entity 7 may define one or more properties of the promotion. In such an embodiment, the advertising entity interfaces 200 may allow the advertising entities 7 to input the properties of the promotion. Optionally, the advertising entity interface 200 is designed to display information about the promotion which is related to the requesting advertising entity. For example, the advertising entity interface 200 is designed to display data obtained through the customer-targeting unit 4 that allows the advertising entities 7 to make an informed decision about future promotions, for example as disclosed in PCT/IL2007/000234, filed on Oct. 26, 2006. Optionally, the advertising entity interface 200 allows the advertising entity 7 to configure the promotion before the execution thereof. It may be used for reports, invoicing, payments, and any other user related activities.

In such an embodiment, the advertising entity 7 may define one or more of the following promotion definitions:

1. The promotional data, which may be any commercial data and/or offer that depicts and/or describes promoted products and/or services.

2. Timing for the promotion—a time and/or a date in which the promotion is conducted. In such an embodiment, the advertising entity 7 decides when the promotion is launched and therefore has the ability to estimate when to expect the positive customer reactions.

3. Number of positive customer reactions—minimum and/or maximum positive customer reactions; a value that defines minimum and/or maximum positive customer reactions to be evoked as a result of the promotion. In such an embodiment, the user may limit the promotional costs to its budget by defining a number of the expected positive customer reactions. Optionally, the user defines the minimum and/or a maximum of positive customer reactions together with the definition of the time and/or the date in which the promotion is conducted. In such a manner, the advertising entity 7 may get ready for the reception of the positive customer reactions as it has the ability to define the amount of the received positive customer reactions and the timing thereof. For example, an advertising entity having a call center that can efficiently handle a certain amount of incoming calls per hour may define a promotion or a number of sequential promotions, each to evoke a limited number of positive customer reactions per hour. In such a manner, the advertising entity may avoid jamming its call center in a certain hour and/or employing excessive work force to staff inoperative or call center.

4. A promotion budget limit—a limit that defines the upper limit of the promotion costs. For example, if the advertising entity 7 enters a certain budget limit, promotional messages are sent to a cumulative number of customers for a certain amount of promotional effort in a manner that the promotion cost is lower than the entered budget limit.

5. A potential customer limitation—A white list defining a group of potential customers and a black list defining a group of unwanted customers.

6. An entry point—including one or more preferred methods for collecting and/or receiving customer reactions, such as SMSs, MMSs, participations in an IVR calls and the outcome thereof, phone calls, mails, email messages, purchases, arrivals to designated locations, or any expression of interest in the promotional data.

7. The reward the advertising entity 7 is willing to pay per message.

8. A budget sum—a sum defining the total amount of resources the advertising entity 7 allocates for acquiring customer reactions.

9. A payment method.

Optionally, all the aforementioned operations, which are performed by the advertising entity 7, are performed by the system operator of the COD system 1, either independently or according to instructions received from the advertising entity 7.

Optionally, the COD system 1 manages multiple promotions in parallel. In such an embodiment, the customer demand unit 2 may set a priority to each one of the bids and may manage a queue of requested promotions according to their priorities. In such a manner, the customer demand unit 2 receives a number of bids and manages the execution of the related promotions according to their priority. Optionally, the priority is determined according to the ratio between the reward and the promotional cost of executing the promotion with the highest response rate or the like.

Optionally, the COD system 1 schedules the time of delivery of each promotion according to a best time of day that the potential customers in the related targeted promotion list may be contacted. Optionally, the best time of day is calculated as described in PCT/IL2006/00402, published as WO2006/111952 on Oct. 26, 2006 and incorporated herein by reference.

As described above, the output unit 3 is designed to execute the promotion according to the targeted promotion list of the customer-targeting unit 4. When the advertising entity 7 wishes to execute a promotion that evokes a predefined number of positive customer reactions, it may use the advertising entity interface 200 for logging into the DOC system 1, bidding for positive customer reactions, and initiating a targeted promotion that is calculated according to the bidding, as described above. Optionally, the advertising entity interface 200 displays a unique “customer on demand” button that generates instructions to the COD system 1 to generate a promotion, optionally immediately, according to the definitions of the request, as described above.

Reference is now made to FIG. 5, which is a schematic illustration of the exemplary targeting tool 8 for identifying and targeting potential customers that is used by the promotion generation unit (not shown) that is described above, according to one embodiment of the present invention. The customer targeting tool 8 includes a discovery unit 80, which is associated with a targeting unit 81. The targeting unit 81 outputs a promotion list 83 that comprises a group of potential customers from a certain database of customer data 82 and used for generating the aforementioned promotion. The discovery unit 80 is configured to analyze customer data 82 regarding, inter alia reactions of customers to promotion activities and other information that is related to the potential customers, optionally as related network interactions.

For clarity, customer data and information about potential customers may be understood as information which originates from one of the following system: roaming systems, billing systems, customer care systems, provisioning systems, service delivery platforms, intelligent network and prepaid systems, data warehouse systems, customer management systems, mediation platforms, Partner management systems, Common service platforms, Mobile Switching Center (MSC), IVR and HLR systems, Wireless Access Point (WAP) gateways, WEB portals, content billing servers, SMS and MMS server systems, voicemail servers. The information about the potential customer may be understood as information about the potential customer roaming behavior, billing information or price plan the potential customer uses, other Customer Relationship Management (CRM) information such as addresses, demographic section, gender and age, and any other form of information about the potential consumer.

A network traffic event or network interaction may also be understood as any communication interaction between a personal computer or mobile phone and one of the following systems: a billing system, a customer care system, a provisioning system, a service delivery communication network, a prepaying system, a data warehouse system, a customer management system, a mediation communication network, a Partner management system, a common service communication network, a Mobile Switch Center (MSC), a roaming system, a HLR or an IVR system, a WAP gateway, a WEB portal, a Content billing server and a voicemail server.

Mobile network interactions may be done for example using one of the following protocols and applications: Wireless Application Protocol (WAP), JAVA, Binary Runtime Environment for Wireless (BREW), 3rd Generation Partnership Project (3GPP) i-mode or other protocols, a technology which is used to enable the user to have Web access, technology which is used to enable sending and receiving SMS, MMS, known protocols of downloading or uploading content, known protocols of subscription to a service or to a product, known protocols of location based information, known protocols of performing IVR calls or any other type of interaction a user can perform with a mobile network.

The traffic events or network interactions comprise descriptive information about a user. Such descriptive information may represent a roaming behavior of the user, the price plans to which the user is registered and Customer Relationship Management (CRM) based information such as customer address, customer demographic sector, customer gender and age, customer profession, etc.

Each analyzed reaction, for example, Optionally reflects a certain customer decision regarding the purchasing of a certain product or a service. The reaction may be positive, negative or any other reaction that reflects the potential customer decision regarding the related promotion activity. Such data is customer data of actual purchasing, and is analyzed by the discovery unit 80 in order to identify groupings of customers. The groupings are differentiated by the customers' reactions and additional information that has been gathered about the customers.

In addition, the discovery unit 80 is used to identify common characteristics of customers who have respond to a previous promotion in a common manner. Based upon the identified common characteristics, the discovery unit 80 generates a customer profile, which is transferred to the targeting unit 81. Targeting unit 81 scans the customer data 82 to assess the similarity of each documented potential customer to the customer profile. Based upon the assessment the targeting unit 81 generates a promotion list 83 that comprises a list of potential customers of the customer data 82 with a correlated assessment.

For example, the discovery unit 80 may be used to analyze the reaction of a batch of customers to a dairy product promotion. The discovery unit 80 differentiates between customers who have responded to the promotion positively and customers who have responded to the promotion negatively or have not responded to the promotion at all. That is to say, the unit differentiates between customers who as a response to the promotion bought the dairy product and customers who as a response to the promotion did not buy the dairy product.

The group of customers who have responded positively to the promotion may be analyzed by the discovery unit 80 to target customers for new promotions. The targeting unit 81 is configured to target customers belonging to groups discovered by the discovery unit 80.

As described above the discovery unit 80 generates a customer profile that is used by the targeting unit 81 to identify a larger group of potential customers who have been assessed as sharing common characteristics with the customer profile.

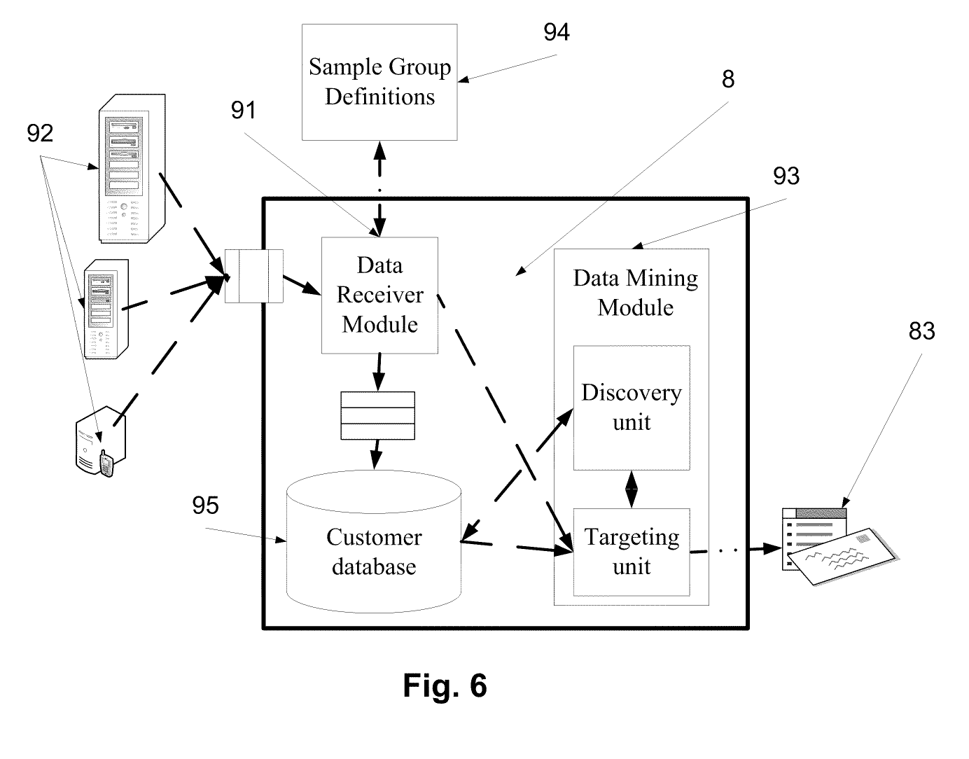

Reference is now made to FIG. 6, which is another schematic illustration of the customer targeting tool 8, according to another embodiment of the present invention. The discovery unit 80, the targeting unit 81, the customer data 82 and the targeted customers 3 are similar to those shown in FIG. 5 above. However, FIG. 6 further comprises a customer database 95 a data receiver module 91 and a data source(s) 92. In addition, in FIG. 6 the discovery unit 80 and the targeting unit 81 comprise a data mining module 93. The data mining model is used by the customer targeting tool 8 to analyze customer data 82 and to output a list of targeted customers 3 that is used as the aforementioned promotion list.

The customer database 95 comprises records and entries. Each record or entry comprises information regarding a certain network interaction and a unique user identifier. The unique user identifiers imply which user is involved in a particular network interaction.

As described above, the discovery unit 80 generates a customer profile that is used as a reference for the targeting unit that generates based upon a promotion list 83. The customer profile is generated according to previous promotion reactions and network interactions. The initial promotion list is used to generate a promotion whose reactions are the basis to generating a customer profile for the succeeding promotion.

Hence, the data receiver module 91 receives a sample group 94. The sample group 94 comprises a make-up of the first promotion list that is generated by the tool for identifying and targeting potential customers, as described below.

The data receiver module 91 translates each received network interaction datum that comprised the unparsed customer data into user interaction entries which are parsed according to a predetermined unified pattern, comprising a parsed batch of customer data 82.

The data mining module 93 stores each potential customer network interaction that has been received from the data receiver module 91 in a designated entry. Each entry is associated with a corresponding customer record. Since the customer records 8 are uniformly parsed, their analysis can be done in a straightforward manner using the data mining module 93, as described below. Optionally, the customer records 8 are stored in a designated repository.

Network interactions may be stored as entries. Each entry comprises subentries, such as interaction occurrence date, interaction occurrence time, interaction type, estimated or known interaction cost, etc.

Since, as mentioned above, the data receiver module 91 may be connected to more than one data source(s) 92, the network interactions, which are received from the data sources, represent interactions from different telecommunication systems.

Optionally, additional related information regarding the potential customer can be stored as additional subentries. For example, additional subentries may comprise information regarding the potential customer's average monthly telephone bill, the potential customer's age, the potential customer's gender, the potential customer's address, the potential customer's occupation, the potential customer's average monthly cellular telephone bill and average usage time, the potential customer's average monthly regular telephone bill and average usage time, the potential customer's average monthly ISP bill and average usage time, etc.

As mentioned above, the targeting unit of the data mining module 93 is configured to target customers. Based upon those targeted customers the data mining module 93 generates a targeted promotion list 83 that is used as an addressee list for the targeted promotion of a certain service or product. The generated targeted promotion list 83 comprises contact information about the potential customers in the list. Optionally, the contact information comprises one or more of the following contact information: a private telephone number, a mobile telephone number, an electronic mail address, a home address, a telephone number at a business location, a fax number, an IP address, a personal ID number, a VOIP user name, etc.

Optionally, each entry of the targeted promotion list 83 further comprises information regarding the best time of day that the potential customers may be contacted. Accordingly, the targeted promotion list 83 can be used to generate promotions at different time periods during the day. Such a targeted promotion may result in an improved response rate.

As depicted in FIG. 6, the targeting unit of the data mining module 93 is configured to receive the sample group definitions 4 via the data receiver module 91. The customer targeting tool 8 is designed for analyzing responses of potential customers to promotions. Based on the analysis, the customer targeting tool 8 generates a new promotion list. However, when the tool for identifying and targeting potential customers has just been initiated, there are no responses that the customer targeting tool 8 can analyze in order to output an initial promotion list.

In order to enable the generation of the initial targeted promotion list 83, sample group 94 is provided to the customer targeting tool 8.

The sample group 94 comprises customers who are documented in the customer records 8. The sample group 94 is used to generate a targeted promotion list 83 that comprises the listed potential customers. After all the matched potential customers have been added to the targeted promotion list, the data mining module 93 outputs the targeted promotion list 83.

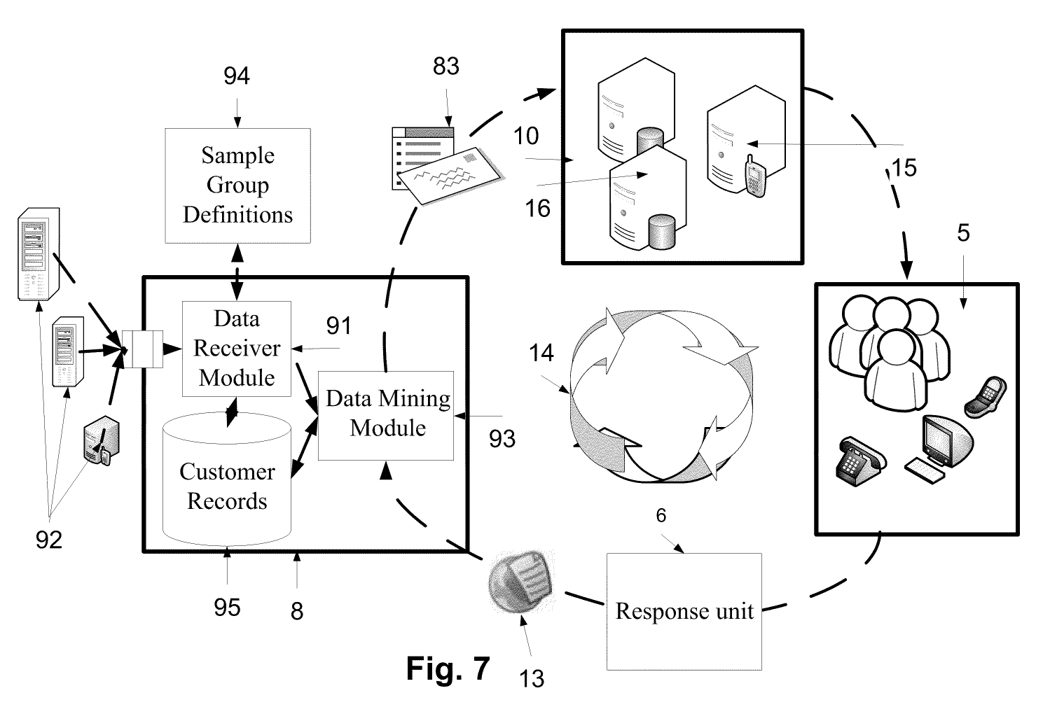

Reference is now made to FIG. 7, which is a schematic illustration of the participants that take part in the generation of the aforementioned list of potential customers, according to one embodiment of the present invention. The customer targeting tool 8 similar to this shown in FIG. 5 above and the promotion list 83 and the data source(s) 92 are similar to those shown in FIG. 6 above. However, FIG. 7 further comprises broadcasting servers 10, a group of potential customers, as shown at 5, response unit 6 and a list of responding customers 13 which may be provided to the customer targeting tool 8 from the response unit 6.

One advantage of the customer targeting tool 8, which is described above, is its ability to learn from the responses and network interactions of the potential customers that have been targeted in the past. The learning procedure enables the customer targeting tool 8 to perform an empirical evaluation of the characteristics of the responding customers.

In one embodiment of the present invention, the customer targeting tool 8 is proactively used to independently initiate a promotion, and to collect the responses to the promotion from customers which responded to the promotion. The customer targeting tool 8 analyzes the characteristics of customers who responded to the promotion and identify one or more common factors among their characteristics. Then, the common factors are matched with the customer records 8 that comprise subentries of the characteristics of potential customers. Based on this match, a group of potential customers is chosen to be promoted on the next promotion of the customer targeting tool 8. Such a proactive tool differs from the passive promotion tools that use existing information for generating a new promotion. Unlike the passive promotion tools, the customer targeting tool 8 independently generates a promotional event and actively gathers responses to the promotional event. Thus, unlike passive promotion tools the customer targeting tool 8 does not relay only existing information but generates events that provide it with information that can be empirically analyzed.

As depicted in FIG. 7, the targeted promotion list 83 is transferred to one or more broadcasting servers 10 that disseminate, via telecommunications media, the promotion according to the targeted promotion list 83. As described above, the listed potential customers receive the promotional content via various telecommunications media.

Optionally, the one or more broadcasting servers 10 are connected to a cellular communication network. Such broadcasting servers 10 can be used for transmitting promotional content directly to the mobile phones of the potential customers who are listed in the targeted promotion list 83.

Broadcasting cellular servers 15 may be used to send a message that comprises promotional content using one or more of the following messaging protocols: an SMS, an MMS, an EMS, a WAP push message a printed message on the monthly bill, or any other messaging protocol or mechanism that can be used to transmit specific content to mobile phones.

More optionally, one or more of the broadcasting servers 16 is connected to a computer network. Such broadcasting servers 10 can be used for transmitting the promotional content directly to the personal computers or to the PDA of potential customers who are listed in the targeted promotion list 83. The connection may be via either land communication or wireless communication.

Broadcasting network servers 16 may be used to send a message that comprises promotional content in one or more of the following messaging protocols: electronic mail, Chat messages, VOIP messages, Pop-Up WebPages, a voicemail message, an automatic IVR call, a printed message on the monthly bill or any other protocol that can be used to transmit specific content to personal computers.

More optionally, the one or more broadcasting servers 10 are connected to a Public Switched Telephone Network. Such broadcasting servers 10 can be used for transmitting promotional content directly to the telephone devices of potential customers who are listed in the targeted promotion list 83.

Broadcasting servers 16 may be used to send a message that comprises the promotional content as an IVR call or as a facsimile message. Subsequent to the sending of the promotional content, the potential customers may act in response to the promotion.

For example, in one embodiment of the present invention, the broadcasting servers comprise a server that is connected to a cellular communication network. In an embodiment of the invention, the listed potential customers receive one or more messages on their mobile phones that offer them a certain product or service. The potential customers may react to the promotion either by sending a reply message to the sender or to a number that has being included in the promotional message.

As depicted in FIG. 7, a reply message or any other response is sent to the response unit 6. The response unit 6 receives the responses of the customers and forwards them to the customer targeting tool 8.

Optionally, the response unit 6 forwards a response list 13 that comprises all the responses which have been accepted during a certain period. The response list 13 is transferred to the customer targeting tool 8. Optionally, the response unit 6 parses the responses according to a predetermined unified pattern before forwarding them. The output response list 13 is transferred directly to the data mining module 93 of the customer targeting tool 8. The customer targeting tool 8 stores the responses to the targeted promotion sent to customers on the targeted promotion list 83 in a designated repository. Each response is associated with a customer record that is designated to store information regarding the corresponding responding customer. Optionally, the responses comprise a record that defines the promotion.

As described above, the promotion lists are sent to a list of designated potential customers. The reactions to the promotions are documented and used to generate a new, more focused promotion lists. However, not all the designated potential customers have actually received the promotion. The potential customer record may not reflect the actual content information of the related potential customer. For example, if a designated potential customer changes his email address or mobile phone number, an SMS or email based targeted promotion fails to target him. It is important to differentiate between potential customers who have been targeted and received the promotion, to those who have not received the promotion in order to correctly estimate the potential customers' reactions to the targeted promotion.

Optionally, the response unit 6 further receives information regarding the promotion activities which have been actually delivered to the designated potential customers. Accordingly, the customers' records are updated to document the reactions of the customers according to the actual delivery status of the promotion offers.

Optionally, each record of the customer records 8 is associated with one or more response vectors. Each response vector stores the responses of the related customers to different targeted promotions.

As depicted in FIG. 7, the procedure of performing a promotion according to a targeted promotion list 83 and gathering the responses to that promotion is cyclical, as shown by arrows 14. The customer targeting tool 8 generates a targeted promotion list 83, which is transferred to broadcasting servers 10. The broadcasting servers 10 are used to generate a targeted promotion according to the targeted promotion list 83 and to send messages to listed potential customers 5. The responses of the listed potential customers 5 to the targeted promotion are recorded in response unit 6 and are sent back to the customer targeting tool 8.

Moreover, since the process is cyclical, targeted promotion lists may be sent only to potential customers who are not listed in the previous targeted promotion list 83. Optionally, the targeting unit 81 of the data mining module 93 verifies that the potential customers in the targeted promotion list 83 do not already subscribe to the promoted service.

Since the targeted promotion may be performed several times, a large number of responses to different targeted promotions may be documented in the customer records 8.

The responses of the listed potential customers 5 comprise information that can be efficiently used by the customer targeting tool 8 during the next promotion. Optionally, the responses of each promotion are updated in a designated table. Each row of the table represents a particular potential customer. Each column of the table represents a particular promotion. Every new targeted promotion adds a new column to the table that represents the responses to that specific targeted promotion.

As described above, the customer targeting tool 8 receives and stores information regarding different network interactions of potential customers.

The information is stored in customer records 8 which are placed in a designated repository.

Optionally, the information regarding the potential customer responses to promotions is added to the already stored information regarding various network interactions the potential customer has performed. Accordingly, the customer records 8 comprise a substantial amount of information regarding each potential customer. The accumulated information about the potential customers is used to classify the potential customers and to generate the aforementioned list of potential customers.

It is expected that during the life of this patent many relevant devices and systems will be developed and the scope of the terms herein, particularly of the terms a system, a promotion, a module, a unit, a network, and a subscriber are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for evoking positive customer reactions to a promotional activity for advertising entities, comprising:
an input unit configured for receiving a bid for at least one positive reaction to a promotional activity from an advertising entity;
a customer-targeting unit configured for generating a promotion list specifying a plurality of potential customers based on said bid, said generated promotion list being calculated to evoke a sufficient amount of positive customer reactions to said promotional activity from said plurality of potential customers to meet said bid; and
an output unit configured for outputting said promotion list.

2. The promoting system of claim 1, wherein said bid comprises a preferred timing for receiving said positive customer reactions, said evoking being performed during said preferred timing.

3. The promoting system of claim 1, wherein said bid comprises a demand for a predefined number of positive customer reactions.

4. The promoting system of claim 1, wherein said promotion list is calculated according to empirical analysis of customer data.

5. The promoting system of claim 1, wherein a cost of promoting said plurality of potential customers is less than a product of said bid and said amount.

6. The promoting system of claim 1, wherein said customer-targeting unit is configured for generating said promotion list automatically.

7. The promoting system of claim 1, wherein said input unit is connected to at least one user interface for allowing an advertising entity to input said bid.

8. The promoting system of claim 7, wherein said at least one user interface is configured for allowing said advertising entity to input at least one promotion property, said customer-targeting unit being configured for generating said promotion list according to said at least one promotion property.

9. The promoting system of claim 8, wherein said at least one promotion property comprises a member of the following group: promotional data, a timing for setting said promotional activity, a pace in which said positive customer reactions being received, a date for setting said promotional activity, a minimum limit for said amount, a maximum limit for the quantity of said amount, a list defining plurality of unwanted potential customers, at least one property defining plurality of unwanted potential customers, a list defining a plurality of wanted potential customers, and at least one property defining plurality of wanted potential customers.

10. The promoting system of claim 7, wherein said at least one user interface is configured for allowing said advertising entity to input a preferred promoting method, said output unit being configured to instruct a distributing unit to conduct the promotional activity according to said preferred promoting method.

11. The promoting system of claim 7, wherein said input unit is connected to said at least one user interface via a computer network.

12. The promoting system of claim 1, wherein said input unit is configured for receiving a plurality of bids for a plurality of promotional activities from a plurality of user interfaces, said customer-targeting unit being configured for generating a plurality of promotion lists based on said plurality of bids, each said promotion list being calculated to evoke at least one positive customer reaction to a respective said promotional activity, said output unit being configured for outputting said plurality of promotion lists.

13. The promoting system of claim 12, wherein said input unit is configured for to prioritize said plurality of bids.

14. The promoting system of claim 1, wherein said output unit is configured for outputting said promotion list to a distributing unit, said distributing unit being configured for distributing the promotional activity according to said promotion list.

15. The promoting system of claim 1, wherein said promoting is performed instantaneously after the reception of said bid.

16. A method for evoking positive customer reactions to a promotional activity for advertising entities, comprising:
a) receiving a bid for a positive customer reaction to a promotional activity from an advertising entity;
b) generating a promotion list specifying a plurality of potential customers based on said bid, said generated promotion list being calculated to evoke a sufficient amount of positive customer reactions to said promotional activity from said plurality of potential customers to meet said bid; and
c) outputting said promotion list.

17. The method of claim 16, wherein the cost of promoting said plurality of potential customers is less than a product of said bid and said amount.

18. The method of claim 16, wherein said bid comprises a predefined promotion period, said generated promotion list being calculated to evoke said positive customer reactions during said predefined promotion period.

19. The method of claim 16, further comprising empirically analyzing customer data before said promotion list generating, being based on said analysis.

20. The method of claim 16, further comprising receiving at least one promotion property, said generating being based on said at least one promotion property.

21. A user terminal for evoking at least one positive customer reaction to a promotional activity, comprising:
a user interface configured for allowing a user to define a reward for a positive reaction to a promotional activity; and
an output unit configured for forwarding said reward to a promotion generating unit via a computer network, said promotion generating unit being configured for conducting a promotion based on said reward, said promotion being calculated to evoke at least one positive customer reaction to said promotional activity for a profitable cost.

22. The user terminal of claim 21, wherein said profitable cost is lower than a product of said reward and the quantity of said at least one positive customer reaction.

23. The user terminal of claim 21, wherein said promotion is conducted to evoke said at least one positive customer reaction immediately.

24. The user terminal of claim 21, wherein said user interface configured for allowing said user to define at least one promotion property, said output unit configured for forwarding said at least one promotion property to said promotion generating unit, said promotion generating unit being configured for conducting said promotion according to said at least one promotion property.

25. A system for evoking at least one positive customer reaction to a promotional activity for advertising entities, comprising:
an input unit configured for receiving from an advertising entity a preferred timing for receiving at least one positive reaction to a promotional activity;
a customer-targeting unit configured for generating a promotion list of potential customers based on said preferred timing, said promotion list being calculated to evoke said at least one positive customer reaction in said preferred timing; and
an output unit configured for outputting said promotion list.
